(19) United States
(12) Patent Application Publication
(10) Pub. No.: US 2014/0232191 A1
(43) Pub. Date: Aug. 21, 2014

(54) CONTACT WIRE SYSTEM FOR TRACTION SUPPLY OF AN ELECTRIC TRACTIVE VEHICLE

(71) Applicants: Aandre Doelling, Erlangen (DE); Michael Lehmann, Erlangen (DE); Stephan Rister, Nuernberg (DE); Axel Schmieder, Leipzig (DE)

(72) Inventors: Aandre Doelling, Erlangen (DE); Michael Lehmann, Erlangen (DE); Stephan Rister, Nuernberg (DE); Axel Schmieder, Leipzig (DE)

(73) Assignee: SIEMENS AKTIENGESELLSCHAFT, MUENCHEN (DE)

(21) Appl. No.: 14/348,734

(22) PCT Filed: Sep. 5, 2012
(86) PCT No.: PCT/EP2012/067295

§ 371 Date: Mar. 31, 2014

(30) Foreign Application Priority Data
Sep. 29, 2011 (DE) 102011083705.1

(51) Int. Cl. H02J 13/00

(52) U.S. Cl. CPC H02J 13/00
USPC 307/42

(57) ABSTRACT

A contact line system is provided for traction supply of an electrical tractive vehicle. It contains a contact line being contacted by a current consumer of the tractive vehicle for energy transmission. It further contains a central substation for converting a supply voltage into a contact line voltage which is electrically connected to the contact line via a section exit for supplying of energy. It additionally contains a protection device for interrupting the energy supply upon recognizing a failure which has a central measurement device for measuring a parameter in the section exit and an evaluation device for recognizing a failure. The protection device has decentrally arranged measurement units for detecting parameters outside of the substation and a data transmission system for transmitting parameter measurement values to the evaluation device. The evaluation device evaluates the decentrally detected parameter measurement values for failure recognition.

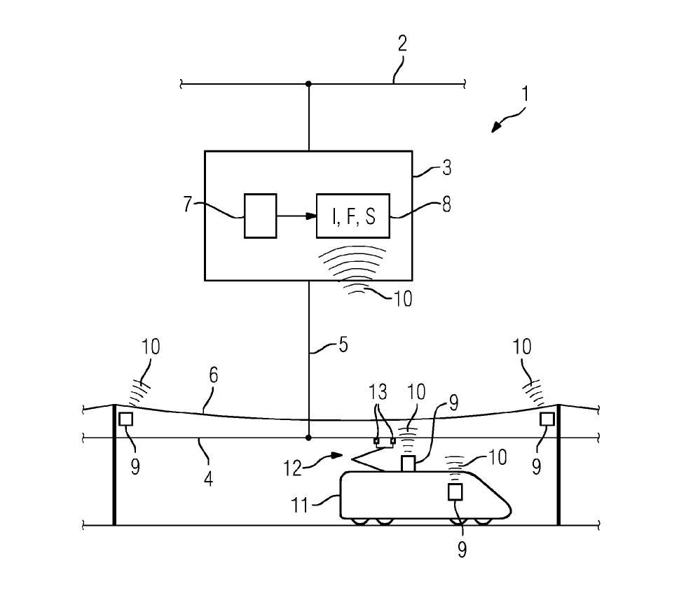

The invention relates to a contact line system for traction. supply of an electric tractive vehicle as claimed in the preamble to claim 1.

Electric tractive vehicles, in particular rail and road vehicles, are powered via contact line systems. Here substations convert a supply voltage of a power grid into a contact line voltage and feed it into the contact line, e.g. into the contact wire of an overhead contact line system or into a conductor rail disposed alongside the track. For operational or technical reasons, a contact line has neutral sections which subdivide the contact line into sections which constitute supply sections that are powered in an electrically isolated manner from one another.

It is known to protect contact line systems from electrical overload by evaluating measured current and voltage values in the track feeders from the substations. If limit values are exceeded or undershot, the power supply is disconnected via circuit breakers. The monitoring is performed in contact line protection relays which are equipped with different protection levels. For both DC and AC supply, different protection levels are used, generally as decided by the operator of the contact line system. Specifically a distinction is made between
overcurrent protection, also known as high current protection,
multilevel time overcurrent protection, in some cases with inrush current detection,
multilevel distance protection, also called impedance protection,
the protection level for monitoring the current, voltage or impedance change per unit of time for distinguishing between operating and short-circuit currents, also called starting level,
current step change protection, thermal overload protection and
time overcurrent protection, also called TOC protection. level, as backup protection in the event of distance protection level failure.

A protection system for contact line systems is increasingly also required to provide selectivity of ins protective measures in order to maximize contact line system availability. Consequently, in addition to their primary protective action, e.g. to protect against high-current short circuits, the protection measures should, as a secondary action, effect selective shutdown of only the contact line section directly affected.

With the increasing numbers of tractive vehicles capable of energy recovery and running at short intervals, i.e. headways, there may be a plurality of tractive vehicles within the supply sections. These tractive vehicles represent electrical loads or generators depending on their driving state—i.e. braking, coasting, accelerating, slowing down. The more tractive vehicles generating energy by regenerative braking, the less energy is supplied is the substation. As a result, the energy is thereby exchanged between the tractive vehicles within the supply section. The protection in the substation can no longer detect these processes and is effectively useless. This behavior is particularly marked nowadays, for example, in the case of high-capacity mass transit systems with low supply voltages and tightly meshed networks.

In high-speed traffic at running speeds of more than 250 km/h the residence time of tractive vehicles within the supply sections is so short that two tractive vehicles are only rarely there simultaneously. This means that virtually no energy exchange occurs between tractive vehicles within a supply section. However, it should be noted that, because of the heavier electric current load, the greater tensile forces and the higher speed of the tractive vehicles, the vehicle- and infrastructure-related mechanical loadings are increased. This results in greater creep movements, mechanical stressing of components, lifting and lateral displacements of conductors, etc. These effects cannot be detected via the existing protection system.

Apart from electric drive technology for rail vehicles, a significant increase in the number of tractive vehicles within a supply section is to be expected on electrified highways, for example. This is also permissible in this case, because the individual output per tractive vehicle is low compared. to track-guided railroad vehicles, e.g. only 500 kW for a truck. In these cases, particularly in down-gradients, increased energy exchange between the vehicles and therefore different current strengths in the contact line compared to the reference measurement in the substations must be taken into account.

However, the more vehicles drawing electrical energy for traction via a contact line, the more important also the availability thereof. The material selection and design of a contact line system defines its basic resistance to loading. With the current protection concept, effects resulting from operation, e.g. climatic influencing factors, worn or defective current collectors, aging of the system, etc. cannot therefore be detected during use. Therefore, without an enhanced protection concept, the increased number of vehicles and associated loading is likely to reduce availability.

The object of the invention is therefore to provide a contact line system of the type mentioned in the introduction, having high availability for use by a large number of tractive vehicles, in particular of tractive vehicles capable of energy recovery, also running simultaneously in a supply section.

This object is achieved according to the invention by a generic contact line system having the features set forth in the characterizing part of claim 1. The invention proceeds from a contact line system for traction supply of an electric tractive vehicle, said system comprising a contact line contactable by a current collector of the tractive vehicle for power transmission. A central substation for converting a supply voltage into a contact line voltage is connected via a track feeder to the contact line to supply power. A protection device for interrupting the supply if a fault is detected has a central measuring device for measuring a characteristic variable in the track feeder and an evaluation device for detecting a fault by evaluating a characteristic variable measurement. According to the invention, the protection device also has decentrally disposed measuring units for measuring characteristic variables outside the substation and a data transmission system for transmitting characteristic variable measurements from the decentralized measuring units to the evaluation device. Said evaluation device is also designed to evaluate decentrally acquired characteristic variable measurements for fault detection. The core element of the invention is the extension of the protection concept to include decentrally acquired characteristic variables by means of spatially distributed measuring units in order to improve the effectiveness of the protection device. The basic principle of the protective action, namely to disconnect the power supply in the track feeders in the event of any overloads or dangerous states, is retained. For the first time, different characteristic variables for infrastructure and tractive vehicles are measured decentrally, i.e. also outside the substation, and incorporated into the protection concept. Data transmission and communication is matched to the greater number of measuring points and the greater volume of data to be transmitted. The availability of the contact line system and hence of the overall electrical system is increased, which improves operational cost-effectiveness and operator acceptance. The decentralized measurement of overhead line currents obviates the need for the contact line sectioning otherwise required for selective protection triggering. This reduces, for example, the electrical losses and increases, the supply voltage in the supply section e.g. by feeding from both ends in mass transit. Lastly, the electrical wear on section isolators is also reduced.

In an advantageous embodiment of the contact line system according to the invention, at least one of the decentrally disposed measuring units is designed to measure a characteristic variable describing a contact line current flowing through the contact line. A precise picture of the current distribution is created by the decentralized measurement of current within the contact line. This enables the thermal protection of the contact line to be improved. This protection still reacts flexibly and reliably even when the number of tractive vehicles increases and power is exchanged between a plurality of tractive vehicles in each supply section.

Preferably measurable as a characteristic variable in a contact line system according to the invention is a component current flowing through a live contact line system component and/or a vehicle current flowing in a tractive vehicle and/or a conductor current flowing through a current-sensitive conductor running parallel to the contact line and/or a current-dependent position parameter of the contact line.

A measuring unit for measuring a component current can, for example, be disposed on cross-span wires or on conductors, e.g. on a messenger wire, wherefrom the electrical current load of the contact line can be calculated indirectly via current distribution factors. The measuring units can be implemented, for example, as current transformers or as magnetic field sensors.

Current measurement can also be performed on tractive vehicles and the characteristic variable measurements transmitted to the evaluation center for desired/actual comparison of said vehicle current. There a total current per contact line section, e.g. for each span length or half or total tension length, can be calculated and compared with the maximum permissible current load of the contact line. Capital investment in additional measuring units can be avoided by measuring vehicle currents via the existing infrastructure, but now transmitting them directly to the substation and feeding them to the protection device. For example, if a desired/actual value comparison of the vehicle currents is carried out, the element responsible for a fault can be ascertained and removed from service until the fault has been repaired.

A conductor current flowing through a current-sensitive conductor, e.g. through an optical waveguide which runs parallel to the messenger wire or another longitudinal conductor of the contact line, can also be measured as the characteristic variable describing the contact line current. The contact line current can therefore be determined continuously without additional transducers.

The contact line current can also be calculated indirectly by measuring current-dependent position parameters of the contact line as a characteristic variable. For example, a linear expansion of the longitudinal conductors of the contact line or a thereby caused lateral movement of the support masts bears a relation to the contact line current.

In a preferred embodiment of she contact line system according to the invention, at least one of the decentrally disposed measuring units is designed to measure a characteristic variable describing a state of the contact line. In addition to the actual distribution of the current flowing through a contact line, according to the inventive protection concept characteristic variables which describe the contact line state are also measured by the measuring units. This critically determines the availability or non-availability of the contact line system. As contact lines cannot be implemented redundantly, such characteristic variables can prevent possible incidents, reduce the information time for fault repair in the event of unavoidable faults or derive state information with selective maintenance tasks for the maintenance operations. For example, consequential thermal reactions of the contact line, e.g. greater linear expansions and the consequences thereof, can be taken into account. This enables current collector de-wirings, setting of the weight stack on the ground or traversing quality impairments due to large line sags to be avoided.

Preferably measurable as a characteristic variable in a contact line system according to the invention, wherein the contact line is constituted by at least one contact wire supported from a catenary system, is a clearance between the contact wires of a multi-pole contact line and/or a lateral position and/or height of the at least one contact wire and/or a tensile force in the at least one contact wire and/or in another longitudinal conductor of the catenary and/or a length change of the at least one contact wire and/or a temperature of the at least one contact wire.

In the case of multi-pole contact lines, a clearance between the contact wires can be monitored decentrally as a characteristic variable an critical locations on the contact line, e.g. via laser sensors. However, this characteristic variable measurement can also be carried out via measuring units on the current collector of a tractive vehicle. Thus a clearance measurement in the contact line catenaries can prevent faults due to a coming-together of the conductors, e.g. short circuits. This enables insulators for separating the phases to be dispensed with at these locations and the traversing quality of the contact line to be improved by thus saved additional loads in the support structure.

By detecting the contact wire lateral position, which can be determined indirectly by measuring climatic data such as wind speed, limit positions can be monitored to prevent current collector de-wiring. Detecting the contact wire height level at a plurality of locations on the contact line system can filter tractive vehicles having abnormally high damage potential or even causing disproportional contact line damage. In the case of excessive damage, such tractive vehicles can be prevented from moving on. Position detection also makes it possible to check whether the contact line is faulty or even if individual conductors are ruptured. If a critical clearance or position change is recorded, for example, a fault can be detected in the substation. Thus, in the event of a rupture, the contact wire is high-impedance grounded by tarmacked subsoil or concrete, wherein, because of the high fault impedance of the short-circuit loop, only small currents occur which cannot be unambiguously detected as faults merely by monitoring the current. This significantly improves the reliability of the electrical contact line system in the event of a fault. However, taking the measured position of the contact line into account is also particularly useful for road vehicles electrically powered via contact lines, because there the braking distances are shorter compared to rail vehicles and therefore reaction maneuvers are possible. Even if infrastructure damage is not detected until later, further consequential damage that would be caused by passage through the affected area can be prevented by rapid braking or lowering of the current collector.

By measuring tensile forces in the conductors of the contact line, a contact line rupture can be detected or the operability of the tensioning devices for the contact line continuously monitored, for example.

Measuring the linear expansion of the at least one contact wire as a characteristic variable or lateral movement of the support masts can prevent the current collector from slipping out in the event of the contact wire being subjected to high thermal or climatic stresses.

The temperature of the at least one contact wire can be measured, for example, via an embedded optical waveguide and indirect calculation of the position of the contact wire.

In a preferred embodiment of the contact line system according to the invention, at least one of the decentrally disposed measuring units is designed to measure a characteristic variable describing a state of the current collector. Detecting the state of the current collector, in particular of its contact strips, extends the inventive protection concept for the contact line system and ensures high availability. Measuring units need not be disposed on each tractive vehicle., but can—then in lower numbers—be part of the fixed infrastructure. Via the arrangement of the measuring units it is possible to define the intervals at which characteristic variables are to be measured and the state therefore diagnosed. Capital investment and maintenance savings are achieved compared to taking measurements from the tractive vehicle. Continuous measurement on each tractive vehicle is unnecessary.

In a contact line system according to the invention, profile changes and/or a temperature distribution in a contact strip of the current collector can preferably be measured as a characteristic variable. Acquiring a contact strip profile by means of video analyses at a plurality of positions on the contact line system enables tractive vehicles to be detected which, because of chipping or excessive wear, have above-average damage potential or even cause disproportional damage. Measuring a temperature distribution of the contact strips on the basis of thermal images enables run-hot contact strips to be determined. If a limit value overshoot in this respect is established via the measuring units within the contact line system, the tractive vehicle in question is informed or even automatically prevented from continuing under electric power. Severe current collector wear, which causes reduced service life, or even contact line damage, e.g. a contact wire rupture, due to the operation of defective or poorly maintained current collectors and contact strips can therefore be prevented.

In an advantageous embodiment of the contact line system according to the invention, the data transmission system is designed for wireless transmission of characteristic variable measurements. All the accruing characteristic variable measurement data of the decentralized measuring units within the contact line system or on tractive vehicles is primarily transmitted via cableless communication, e.g. in accordance with the UMTS or GSM-R standards, to the central evaluation device of the protection equipment.

In another advantageous embodiment of the contact line system according to the invention, the data transmission system is designed such that characteristic variable measurements are transmitted between tractive vehicles. Transmission of characteristic variable measurements can advantageously take place so as to include the communications devices of the tractive vehicles, which, with appropriate design of the interfaces, become usable for evaluation in the evaluation device.

In another preferred embodiment of the contact line system according to the invention, at least one of the decentrally disposed measuring units has pre-processing means for decentralized digitization and filtering of the acquired characteristic variable measurements. Because of the large number of characteristic variables to be measured in a spatially extensive contact line system, measurement filtering must take place even within the measuring units. Otherwise, transmission of the measured values to a center would require an excessively large volume of data. Consequently, clear limits must be pre-set for the pre-processing means for evaluating a state. This enables the data volume of characteristic variable measurements to be limited by aggregation and digitization.

Further features and advantages will emerge from the description of an exemplary embodiment with reference to the accompanying drawings, in the single FIGURE of which a contact line system according to the invention s schematically illustrated.

According to the single FIGURE, a contact line system 1 for traction supply of an electric tractive vehicle 11, e.g. of a rail or road vehicle, has a substation 3, a contact line 4 and a protection device. In the central substation supply voltage which is provided via a supply line 2 of a power grid is converted into contact line voltage which is fed into the contact line 4 via a track feeder 5. In the exemplary embodiment shown, the contact line 4 s constituted by a contact supported from a messenger wire 6 of an overhead catenary. The overhead catenary is suspended from supports which can be constituted by masts or structures. Not shown are contact line system components such as cross-span wires, tensioning devices, cables, neutral sections, grounding and disconnecting switches, and the like. The substation 3 supplies a supply section of the contact line 4, said supply section being electrically isolated from adjacent supply sections by neutral sections. To transmit power to the tractive vehicle 11, the latter comprises a current collector (pantograph) 12 which can be brought into sliding contact with the contact line 4. For this purpose the current collector 12 has a collector head having two contact strips 13 disposed one behind the other in the direction of travel. In order to disconnect the power supply to the contact line 4 in the event of a fault, the protection equipment comprises a central measuring device 7 for measuring electrical characteristic variables such as currents or voltages in or on the track feeder 5. The characteristic variable measurements are fed to an evaluation device 8 of the protection equipment for evaluation in respect of fault detection. Depending on the protection level, the characteristic variable measurements are compared with predefinable threshold values, the over- or undershooting of which is construed as a fault in the supply section.

However, according to the invention, the protection device has a plurality of other decentrally disposed measuring units 9 which measure other characteristic variables I, F, S outside the substation 3. The protection device also comprises a data transmission system 10 for transmitting the decentrally acquired characteristic variable measurements from the measuring units 9 to the evaluation device 8. For this purpose the data transmission system 10 comprises transmitting and receiving means (not shown) for wireless data transmission. In the evaluation device 8, not only the centrally acquired but also the decentrally acquired characteristic variable measurements are evaluated to detect faults.

For this purpose, some of the decentrally disposed measuring units 9 are designed to measure a characteristic variable I describing a contact line current flowing through the contact line 4. Measurable as a characteristic variable I of the contact line current is, for example, a component current flowing through a live contact line system component, e.g. through the messenger wire 6, from which component current the contact line current can be determined via current distribution factors. Also measurable as a characteristic variable I of the contact line current is a vehicle current flowing in a tractive vehicle 11 negotiating the supply section. Additionally measurable as a characteristic variable I of the contact line current is a conductor current flowing through a current-sensitive conductor running parallel to the contact line 4, e.g. an optical waveguide incorporated in the messenger wire 6. A current-dependent position parameter of the contact line 4 can also be measured as a characteristic variable I of the contact line current, from which parameter the contact line current flowing can be back-calculated by means of the current-dependent change in length of the contact line 4. Altogether the decentrally acquired characteristic variable measurements provide an actual distribution of the contact line current along the supply section for evaluation in the evaluation device 9 of the protection device. Faults which result from a plurality of in particular regenerative tractive vehicles 11 simultaneously negotiating the supply section and which are not detected by only evaluating currents measured centrally in the track feeder 5 can therefore be detected, thereby increasing the availability of the contact line system according to the invention 1.

Of the decentrally disposed measuring units 9, others are designed to measure a characteristic variable F which describes a clearance of the contact line 4. For example, a clearance between the contact wires of a multi-pole contact line 4 can be measured as a characteristic variable F of the contact line state. Likewise, a lateral position/or height of the at least one contact wire can be measured as a characteristic variable F of the contact line state. A tensile force in the at least one contact wire and/or in another longitudinal conductor of the catenary can also be measured as a characteristic variable F of the contact line state. In addition, a change in length of the at least one contact wire can be measured as a characteristic variable F of the contact line state. Also a temperature of the at least one contact wire can be measured as a characteristic variable F of the contact line state. Faults on the contact line 4 that have occurred or are imminent, such as contact wire ruptures, defective tensioning devices or short circuits, can be detected via these position parameters and the other state parameters. These characteristic variable measurements together with the associated measurement time and location data can be utilized in the evaluation device 8 of the protection device for selective operation and maintenance instructions. Thus, tractive vehicles 11 can be prevented from entering the affected area of the supply section in order to avoid slotting-in with more disastrous consequences or de-wiring of the current collector 12 thereof. A selective instruction concerning the location and type of damage speeds up the corrective maintenance process and increases the availability of the inventive contact line system 1.

Other decentrally disposed measuring units 9 are designed to measure a characteristic variable S which describes a state of the current collector 12. For example, profile changes and/or a temperature distribution of a contact strip 13 of the current collector 12 can be measured as a characteristic variable S of the current collector state. The corresponding measuring units 9 can be constituted by video cameras and/or thermal imaging cameras and disposed on the tractive vehicles 11 themselves or even preferably as part of the infrastructure to save measuring units 9. If said measuring units 9 are disposed in a fixed manner, the state diagnostics interval can be set via the spacing between the measuring units 9. Chipping or excessive wear of a contact strip 13 can be detected from the profile changes. The thermal image indicates the surface heating of the contact strip 13 and therefore enables so-called “running hot” to be detected. In the evaluation device 8 of the protection device, on the basis of these characteristic variable measurements, operating instructions can be issued for tractive vehicles 11 whose current collectors 12 are in a poor condition in order to prevent damage to the contact line 4 and accompanying faults. This again increases the availability of the contact line system 1 according to the invention.

In its data transmission sections, the wireless data transmission system 10 advantageously uses the possibly available means of communication between tractive vehicles 11 to transmit the characteristic variable measurements from the measuring units 9 to the evaluation device 8. In order to minimize the volume of data transmitted, decentrally disposed measuring units 9 have pre-processing means which decentrally digitize the characteristic variable measurements acquired and filter them in respect of the relevance of the measurement data to be transmitted. Thus, threshold values which indicate problem-free characteristic variable behavior can be predefined in the pre-processing means. Data transmission is then initiated only if a threshold value is exceeded.

1-10. (canceled)

11. A contact line system for traction supply of an electric tractive vehicle, the contact line system comprising:
a contact line contactable by a current collector of the tractive vehicle for power transmission;
a track feeder;
a central substation for converting a supply voltage into a contact line voltage, said central substation being electrically connected to said contact line via said track feeder to supply power; and
a protection device for disconnecting the power if a fault is detected, said protection device having a central measuring device for measuring a characteristic variable in said track feeder and an evaluation device for detecting the fault by evaluating a characteristic variable measurement, said protection device having decentrally disposed measuring units for acquiring characteristic variables outside of said central substation and a data transmission system for transmitting decentrally acquired characteristic variable measurements from said decentrally disposed measuring units to said evaluation device, wherein said evaluation device configured to evaluate also the decentrally acquired characteristic variable measurements for fault detection, wherein at least one of said decentrally disposed measuring units configured to measure the characteristic variable describing a state of the current collector.

12. The contact line system according to claim 11, wherein at least one of said decentrally disposed measuring units measures a characteristic variable describing a contact line current flowing through said contact line.

13. The contact line system according to claim 12, wherein the characteristic variable measured is selected from the group consisting of:
a component current flowing through a live contact line system component;
a vehicle current flowing in the electric tractive vehicle;
a conductor current flowing through a current-sensitive conductor running parallel to said contact line; and
a current-dependent position parameter of said contact line.

14. The contact line system according to claim 11, wherein at least one of said decentrally disposed measuring units measures a characteristic variable describing a state of said contact line.

15. The contact line system according to claim 14, wherein:
said contact line is constituted by at least one contact wire supported from a catenary; and
the characteristic variable measured is selected from the group consisting of:
a clearance between contact wires of said contact line being a multi-pole contact line;
a lateral position and/or height of said at least one contact wire;
a tensile force in said at least one contact wire and/or in another longitudinal conductor of the catenary;
a change in length of said at least one contact wire; and
a temperature of said at least one contact wire.

16. The contact line system according to claim 11, wherein profile changes and/or a temperature distribution in a contact strip of the current collector can be measured as one of the characteristic variables.

17. The contact line system according to claim 11, wherein said data transmission system is configured for wireless transmission of the decentrally acquired characteristic variable measurements.

18. The contact line system according to claim 11, wherein said data transmission system is configured such that the decentrally acquired characteristic variable measurements are transmitted between tractive vehicles.

19. The contact line system according to claim 11, wherein at least one of said decentrally disposed measuring units has a pre-processing device for decentralized digitization and filtering of the decentrally acquired characteristic variable measurements.
